(19) United States
(12) Patent Application Publication
(10) Pub. No.: US 2017/0272775 A1
(43) Pub. Date: Sep. 21, 2017

(54) OPTIMIZATION OF INTERFRAME PREDICTION ALGORITHMS BASED ON HETEROGENEOUS COMPUTING

(71) Applicant: Hua Zhong University of Science Technology, Wuhan, Hubei (CN)

(72) Inventors: Pengcheng WANG, Wuhan, Hubei (CN); Wenbin JIANG, Wuhan, Hubei (CN); Xiaofei LIAO, Wuhan, Hubei (CN); Hai JIN, Wuhan, Hubei (CN)

(73) Assignee: Hua Zhong University of Science Technology, Wuhan, Hubei (CN)

(21) Appl. No.: 15/301,037

(22) PCT Filed: Nov. 19, 2015
(86) PCT No.: PCT/CN2015/095039

§ 371 Date: Sep. 30, 2016

(51) Int. Cl. H04N 19/533; H04N 19/54

(52) U.S. Cl. CPC H04N 19/533; H04N 19/54

(57) ABSTRACT

In at least one embodiment, a motion estimation method may include dividing a first video frame to be estimated into a plurality of macroblocks, in which each of the macroblocks includes a plurality of sub-blocks. The method may further include determining a sampling pattern for each sub-block based on visual data of the sub-block, and determining a prediction motion vector for each sub-block by performing a pre-search based on the sampling pattern of the sub-block. The method may further include determining a search template for each macroblock based on the prediction motion vector of each sub-block within the macroblock, and determining a prediction motion vector for each macroblock by performing a secondary search based on the search template of the macroblock.

### TECHNICAL FIELD The embodiments described herein relate generally to video compression, and more specifically to interframe prediction algorithms.

### BACKGROUND

Video compression uses modern coding techniques to reduce redundancy in video data. Most video compression algorithms and codecs combine image compression and motion compensation to significantly reduce the data rate.

Motion compensation is an algorithmic technique used to predict a frame in a video, given the previous and/or future frames by accounting for motion of the camera and/or objects in the video. Motion compensation describes a frame in terms of the transformation of a reference frame to the current frame. Often, for many frames of a video, the only difference between one frame and another is the result of either the camera moving or an object in the frame moving. In reference to a video file, this means much of the information that represents one frame will be the same as the information used in the next frame. Using motion compensation, a video stream will contain some full (reference) frames; then the only information stored for the frames in between would be the information needed to transform the previous frame into the next frame.

In MPEG, images are predicted from previous frames (P frames) or biclirectionally from previous and future frames (B frames). B frames are more complex because the image sequence must be transmitted/stored out of order so that the future frame is available to generate the B frames. After predicting frames using motion compensation, the coder finds the error (residual) which is then compressed and transmitted. In block motion compensation, the frames are partitioned in blocks of pixels, e.g., macroblocks of 16×16 pixels in MPEG. Each block is predicted from a block of equal size in the reference frame. The blocks are not transformed in any way apart from being shifted to the position of the predicted block. This shift is represented by a motion vector.

A block matching algorithm is used to locate matching macroblocks in a sequence of video frames for the purpose of motion estimation. The underlying supposition of motion estimation is that the patterns corresponding to objects and background in a frame of a video sequence move within the frame to form corresponding objects in the subsequent frame. This can be used to discover redundancy in the video sequence, increasing the effectiveness of video compression by defining the contents of a macroblock by reference to the contents of a known macroblock which is minimally different.

A block matching algorithm may divide the current frame of a video into macroblocks and comparing each of the macroblocks with a corresponding block and its adjacent neighbors in a nearby frame of the video. A vector is created that models the movement of a macroblock from one location to another. This movement, calculated for all the macroblocks comprising a frame, constitutes the motion estimated in a frame.

In recent years, multimedia applications have developed rapidly and presented a rapid growth in user data and video processing software. In order to solve the problem of high occupancy rate of bandwidth caused by the large volume of multimedia data, many codec standards have emerged, including H.263, MPEG2, MPEG4, H.264, etc. These codec standards make the compression ratio of video data increase greatly. But high compression ratio is realized by the complex coding algorithms, and under an environment of high concurrency and real-time coding, the computational load of the coding process is large for the backend server.

In its most basic form, the GPU (graphics processing unit) generates 2D and 3D graphics that enable window-based operating systems, graphical user interfaces, video games, visual imaging applications, and video. The modern GPU is a highly parallel, highly multi-threaded multiprocessor optimized for visual computing. To provide real-time visual interaction with computed objects via graphics, images, and video, the GPU has a unified graphics and computing architecture that serves as both a programmable graphics processor and a scalable parallel computing platform.

PCs may combine a CPU with a GPU to form heterogeneous systems. The CPU consists of a few cores optimized for sequential serial processing while the GPU has a massively parallel architecture consisting of thousands of smaller, more efficient cores designed for handling multiple tasks simultaneously. Together, these two types of processors comprise a heterogeneous multiprocessor system. The best performance for many applications comes from utilizing both the CPU and the GPU.

### SUMMARY

Technologies are generally described for interframe prediction algorithms

In at least one embodiment, a motion estimation method may include dividing a first video frame to be estimated into a plurality of macroblocks, in which each of the macroblocks includes a plurality of sub-blocks. The method may further include determining a sampling pattern for each sub-block based on visual data of the sub-block, and determining a prediction motion vector for each sub-block by performing a pre-search based on the sampling pattern of the sub-block. The method may further include determining a search template for each macroblock based on the prediction motion vector of each sub-block within the macroblock, and determining a prediction motion vector for each macroblock by performing a secondary search based on the search template of the macroblock.

In at least one other embodiment, a non-transitory computer-readable medium may store executable instructions that cause a computing device to divide a first video frame to be estimated into a plurality of macroblocks, each of the macroblocks including a plurality of sub-blocks; determine a sampling pattern for each sub-block based on visual data of the sub-block; determine a prediction motion vector for each sub-block by performing a pre-search based on the sampling pattern of the sub-block; deteimine a search template for each macroblock based on the prediction motion vector of each sub-block within the macroblock; and determine a prediction motion vector for each macroblock by performing a secondary search based on the search template of the macroblock.

In yet another embodiment, an apparatus may include a processor and a memory that stores executable instructions that, upon execution, may cause the apparatus to: divide a first video frame to be estimated into a plurality of macroblocks, each of the macroblocks including a plurality of sub-blocks; determine a sampling pattern for each sub-block based on visual data of the sub-block; determine a prediction motion vector for each sub-block by performing a pre-search based on the sampling pattern of the sub-block; determine a search template for each macroblock based on the prediction motion vector of each sub-block within the macroblock; and determine a prediction motion vector for each macroblock by performing a secondary search based on the search template of the macroblock.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example module process flow by which at least aspects of interframe prediction may be implemented;

FIG. 2A shows an example sub-block template including four sampling points by which at least aspects of interframe prediction may be implemented;

FIG. 2B shows an example sub-block template including eight sampling points by which at least aspects of interframe prediction may be implemented;

FIG. 3 shows an example process flow of an interframe prediction system by which at least aspects of interframe prediction may be implemented;

FIG. 4 shows an example process flow by which at least aspects of interframe prediction may be implemented;

FIG. 5A shows a block diagram illustrating an example heterogeneous computer system architecture by which at least aspects of interframe prediction may be implemented; and

FIG. 5B shows a block diagram illustrating another example heterogeneous computer system architecture by which at least aspects of interframe prediction may be implemented, all arranged in accordance with at least some embodiments described herein.

### DETAILED DESCRIPTION

In the following detailed description, reference is made to the accompanying drawings, which form a part of the description. In the drawings, similar symbols typically identify similar components, unless context dictates otherwise. Furtheimore, unless otherwise noted, the description of each successive drawing may reference features from one or more of the previous drawings to provide clearer context and a more substantive explanation of the current example embodiment. Still, the illustrative embodiments described in the detailed description, drawings, and claims are not meant to be limiting. Other embodiments may be utilized, and other changes may be made, without departing from the is spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure realizes a video coding process based on a heterogeneous multiprocessor computer system. The video coding process may include the following modules:

An interframe prediction module implements coding compression by using the time-domain correlation between adjacent frames in a video frame sequence to reduce and remove the time redundancy in the frame sequence.

An intraframe prediction module implements coding compression by using the space-domain correlation between adjacent areas in a video frame to reduce and remove the space-domain redundancy between intraframe pixels.

An integer transform and quantization module in which the integer transform mode implements a transformation of video information from a pixel domain to a frequency domain, and data compression is achieved without significantly affecting the quality of the video by discarding some high frequency information. The quantization mode realizes data compression by adopting different quantization step sizes for the video data having different characteristics.

An entropy coding module uses context-adaptive binary arithmetic coding (CABAC) and context-adaptive variable-length coding (CAVLC) algorithms to fit probability distribution characteristics of characters in the video code stream by look-up table and context switching.

An inverse quantization/inverse integer transform and loop filter module processes the coded video data stream using a decoded frame instead of an original encoded frame to guarantee the consistency of reference frame information, thereby avoiding error accumulation and shift in a coding process of the subsequent frames.

The present algorithm focuses on parallelization optimization of the interframe prediction module. The interframe prediction module may be divided into four parts: motion vector prediction module, adaptive motion estimation module, tree merging and optimal motion vector selection module, and mode decision module.

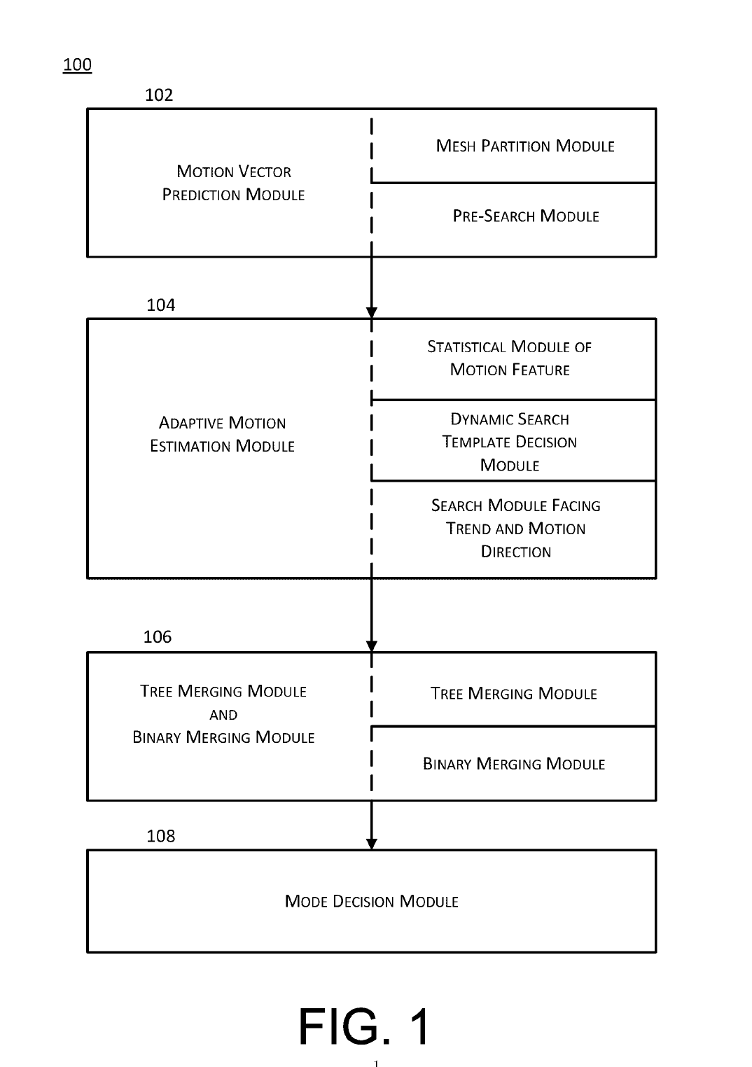

FIG. 1 shows an example module processing flow 100 of operations by which at least aspects of interframe prediction may be implemented, arranged in accordance with at least some embodiments described herein. As depicted, module processing flow 100 may include sub-processes executed by various components that are part of the interframe prediction module. However, implementation of module processing flow 100 is not limited to such components, as obvious modifications may be made by re-ordering two or more of the sub-processes described here, eliminating at least one of the sub-processes, adding further sub-processes, substituting components, or even having various components assuming sub-processing roles accorded to other components in the following description. Module processing flow 100 may include various operations, functions, or actions as illustrated by one or more of blocks 102, 104, 106, and/or 108. Module processing flow 100 may begin at block 102.

Block 102 (Motion Vector Prediction Module) may refer to setting the size of a pre-processed block based on the setting and statistical information of the image (Mesh Partition Module). For the simpler and more gently-varied areas of the image, a sampling of relatively sparse pixels may be adopted. Each pre-processed block may include a minimum of four sampling points (or pixels) to ensure an effective search process.

Block 102 may also refer to using the appropriate sampling template (and sampling points) for each 4×4 sub-block and performing a partial matching computation as a pre-search for each corresponding prediction block (Pre-Search Module). Module processing flow 100 may continue from block 102 to block 104.

Block 104 (Adaptive Motion Estimation Module) may refer to determining a prediction motion vector for each 4×4 sub-block based on a statistical correlation (e.g., space-domain correlation) between adjacent areas in a video frame sequence (Statistical Module of Motion Feature). This prediction motion vector may be selected as a prediction motion vector candidate for the 16×16 macroblock that includes the 4×4 sub-block. Each prediction motion vector candidate (or each search position candidate) for each macroblock may be mapped to a different processing thread of the GPU.

Block 104 may also refer to using an adaptive search strategy based on each prediction motion vector candidate for each macroblock (Dynamic Search Template Decision Module). For example, if a prediction motion vector candidate indicates a block having intense motion (and a larger prediction error), a search template with a correspondingly large step-size and large range may be adopted. Similarly, if a prediction motion vector candidate indicates a block having less motion (and a smaller prediction error), a search template of correspondingly less range and finer granularity may be adopted.

In addition, the motion direction of the prediction motion vector candidate may be used to further refine the search template to account for a facing direction of the search mechanism (Search Module Facing Trend and Motion Direction). Due to the single-instruction-multiple-data (SIMD) nature of the GPU, the search template of a specified block may be mapped using x and y coordinates of the prediction motion vector candidate to ensure that the SIMD structure of the concurrent program is not destroyed. Based on the above strategy, motion estimation based on facing direction and motion characteristics may be achieved. Module processing flow 100 may continue from block 104 to block 106.

Block 106 (Tree Merging Module and Binary Merging Module) may refer to calculating the cost of each 4×4 sub-block of each 16×16 macroblock of the current frame in each candidate position. Then a merger strategy (based on tree blocks) may be used to calculate the cost of 4×8 blocks, 8×4 blocks, 8×8 blocks, 8×16 blocks, 16×8 blocks, and 16×16 blocks in each candidate position within the search window (Tree Merging Module).

Block 106 may also refer to computing the optimal prediction motion vector of each mode (blocks of each size) using binary merging (Binary Merging Module). For example, as each thread of the GPU is used to process the cost of a specified block at the specified position, the thread ID (tid) in the block of the GPU may correspond to the position of the candidate point, so that two arrays are used in which one array may be used to store the cost in different positions, and the other array may be used to store the optimal position corresponding to the cost. After binary merging, a template subscript corresponding to the optimal motion vector may be deposited in position of the specified mode array of the specified block. Module processing flow 100 may continue from block 106 to block 108.

Block 108 (Mode Decision Module) may refer to using the CPU to choose the optimal prediction mode as well as the corresponding motion vector thereof in a variety of block modes. Due to the higher number of judgment statements and lower amount of calculation work, this mode decision process may be transferred to the CPU while the GPU may perform the processing of the next frame. Module processing flow 100 may thus end.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

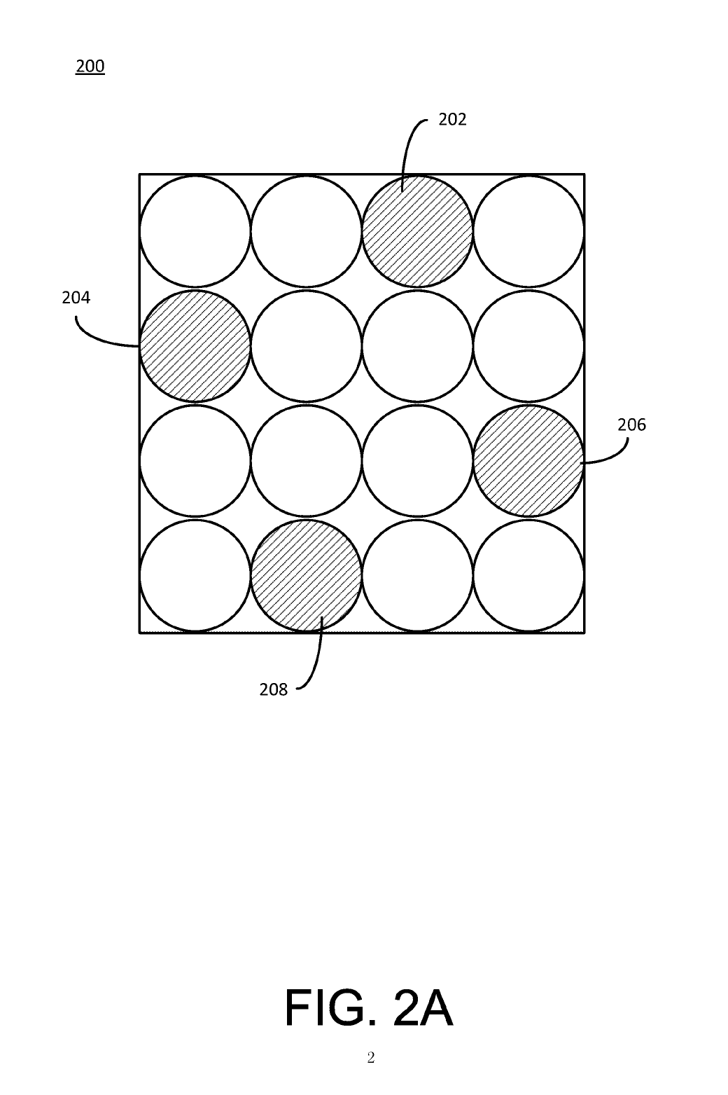

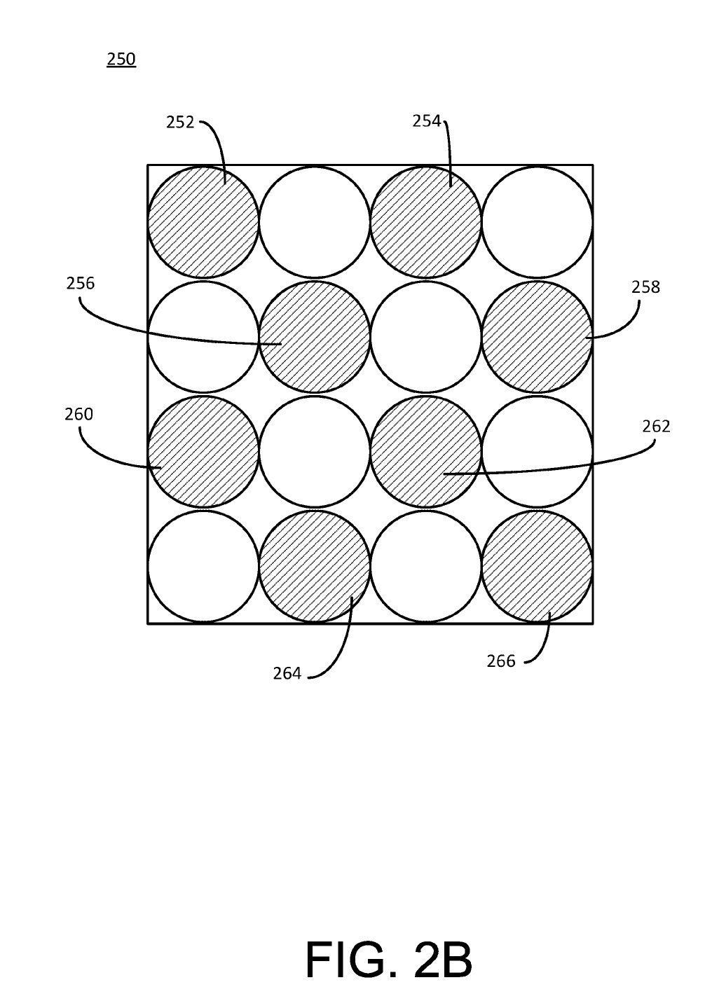

FIG. 2A shows an example 4×4 sub-block template 200 including only four sampling points (202, 204, 206, 208). Such a sampling template corresponds to a gently-varied area of the image. Otherwise, for more complicated areas of the image, the sampling pattern may be relatively dense to ensure a more accurate search process.

FIG. 2B shows an example 4×4 sub-block template 250 including eight sampling points (252, 254, 256, 258, 260, 262, 264, 266). Such a sampling template corresponds to an area of the image having greater complexity and detail.

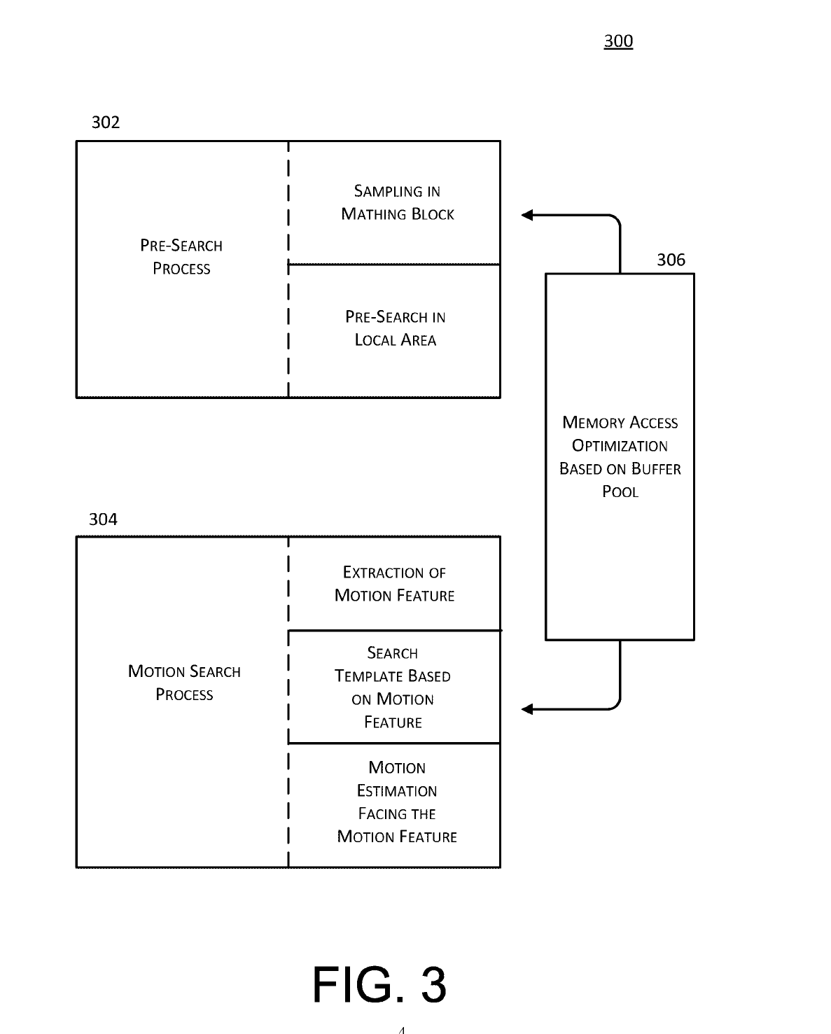

FIG. 3 shows an example processing flow 300 of the interframe prediction system, arranged in accordance with at least some embodiments described herein. As depicted, processing flow 300 may include sub-processes executed by various components that are part of the interframe prediction system. However, implementation of processing flow 300 is not limited to such components, as obvious modifications may be made by re-ordering two or more of the sub-processes described here, eliminating at least one of the sub-processes, adding further sub-processes, substituting components, or even having various components assuming sub-processing roles accorded to other components in the following description. Processing flow 300 may include various operations, functions, or actions as illustrated by one or more of blocks 302, 304, and/or 306. Processing flow 300 may begin at block 302.

Block 302 (Pre-Search Process) is similar to block 102 from FIG. 1, and may refer to setting the size of a pre-processed block (Sampling in Mathing Block), and using the appropriate sampling template to perform a pre-search (Pre-Search in Local Area).

Block 304 (Motion Search Process) is similar to block 104 from FIG. 1, and may refer to determining a prediction motion vector for each sub-block (Extraction of Motion Feature), using an adaptive search strategy based on each prediction motion vector candidate for each macroblock (Search Template Based on Motion Feature), and further refining the search template to account for a facing direction of the search mechanism (Motion Estimation Facing the Motion Feature). As a result, motion estimation based on facing direction and motion characteristics may be achieved.

Block 306 (Memory Access Optimization Based On Buffer Pool) may refer to an optimization strategy based on buffer pools of shared cache. The cache areas of shared cache are limited, and when the number of blocks is greater than that of shared memory of the GPU, the GPU may use the shared cache switching to realize latency hiding. So the limited areas of shared cache may need to be made full use of, a strategy of buffer pool is put forward for this. The shared cache areas may be encapsulated in the form of basic processing units, and cache may be allocated when a memory access request appears. After usage, the shared cache unit should be returned. If the application is unsuccessful, the thread may fetch data from the global cache.

The previous full search solutions expanded the size of the search domain by increasing the number of concurrent threads. However, the number of threads is generally 256 or 512 in each block based on the characteristics of the Compute Unified Device Architecture (CUDA) framework. If the number of mapped threads in shared memory is more than this number, concurrency performance will be decreased. If the size of a search domain is increased by increasing the number of blocks, the multiple threads used to process a macroblock will distribute in multiple blocks, so the communication between threads must be implemented by the shared storage units, which can lead to the increase of memory access time delay, thereby decreasing the processing speed of the whole module.

Therefore, a new iterative search strategy is provided which not only ensures that the effective search domain size will not be reduced, but also adds an information mining module between the pre-search and the secondary search, and in which the path, step length, and search domain size of the secondary search are determined by arrangement, aggregation and analysis of pre-search information, so that the computing resources are centralized on the area where the optimal point may occur.

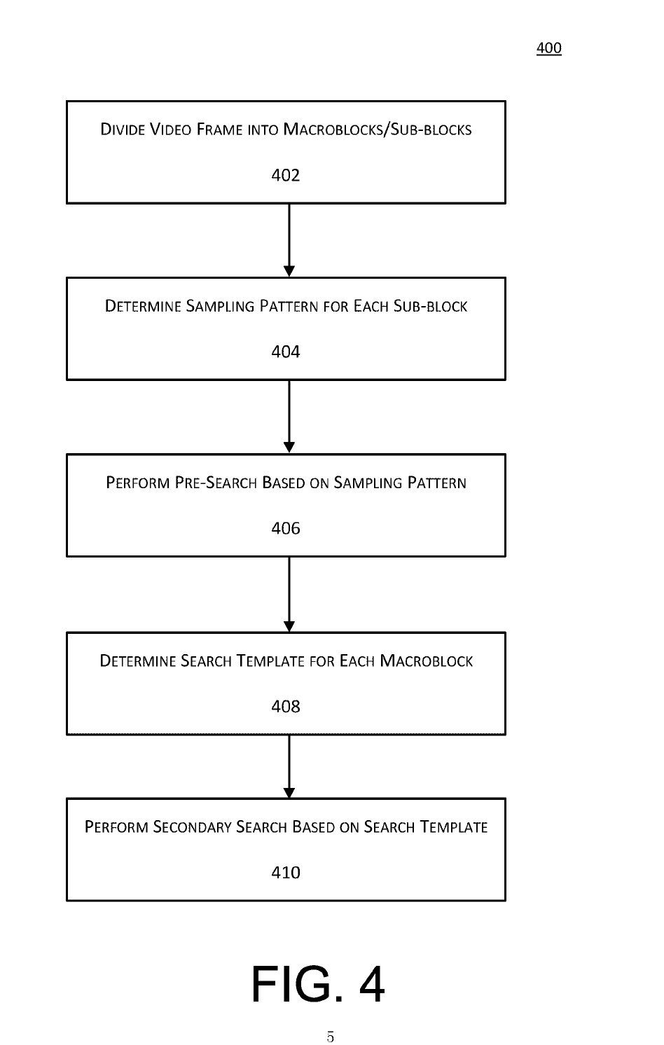

FIG. 4 shows an example processing flow 400 of operations by which at least aspects of interframe prediction (motion estimation) may be implemented, arranged in accordance with at least some embodiments described herein. As depicted, processing flow 400 may include operations executed by various components that are part of the interframe prediction system. However, implementation of processing flow 400 is not limited to such operations, as obvious modifications may be made by re-ordering two or more of the operations described here, eliminating at least one of the operations, adding further operations, substituting components, or even having various components assuming sub-processing roles accorded to other components in the following description. Processing flow 400 may include various operations, functions, or actions as illustrated by one or more of blocks 402, 404, 406, 408 and/or 410. Processing flow 400 may begin at block 402.

Block 402 may refer to an interframe prediction module dividing or partitioning a video frame into macroblocks (e.g., 16×16 pixels), where each of the macroblocks includes a plurality of sub-blocks (e.g., 4×4 pixels). As described above, a macroblock is a processing unit in video compression formats based on linear block transforms, such as the discrete cosine transform (DCT). Formats which are based on macroblocks include MPEG2, H.263, MPEG4, and H.264. Processing flow 400 may continue from block 402 to block 404.

Block 404 may refer to a mesh partition module determining the appropriate sampling pattern or template for each sub-block based on visual data of the sub-block. For example, for simpler areas of the image, a sampling of relatively sparse pixels may be adopted. For more complex areas of the image, a sampling of relatively dense pixels may be used. Processing flow 400 may continue from block 404 to block 406.

Block 406 may refer to a pre-search module performing a pre-search based on the sampling pattern of each sub-block to determine a prediction motion vector for the sub-block. For example, the pre-search module may use the appropriate sampling pattern for each sub-block and perform a partial matching computation as a pre-search for each corresponding prediction block. An adaptive motion estimation module may then determine a prediction motion vector for each sub-block based on a statistical correlation between adjacent areas in a video frame sequence. Processing flow 400 may continue from block 406 to block 408.

Block 408 may refer to a dynamic search template decision module determining a search template for each macroblock based on the prediction motion vector of each sub-block within the macroblock. For example, if a prediction motion vector candidate indicates a block having intense motion (and a larger prediction error), a search template with a correspondingly large step-size and large range may be adopted. Similarly, if a prediction motion vector candidate indicates a block having less motion (and a smaller prediction error), a search template of correspondingly less range and finer granularity may be used. In addition, the motion direction of the prediction motion vector candidate may be used to further refine the search template to account for a facing direction of the search mechanism. Processing flow 400 may continue from block 408 to block 410.

Block 410 may refer to a search module performing a secondary search based on the search template of each macroblock to determine a prediction motion vector for the macroblock. Processing flow 400 may thus end.

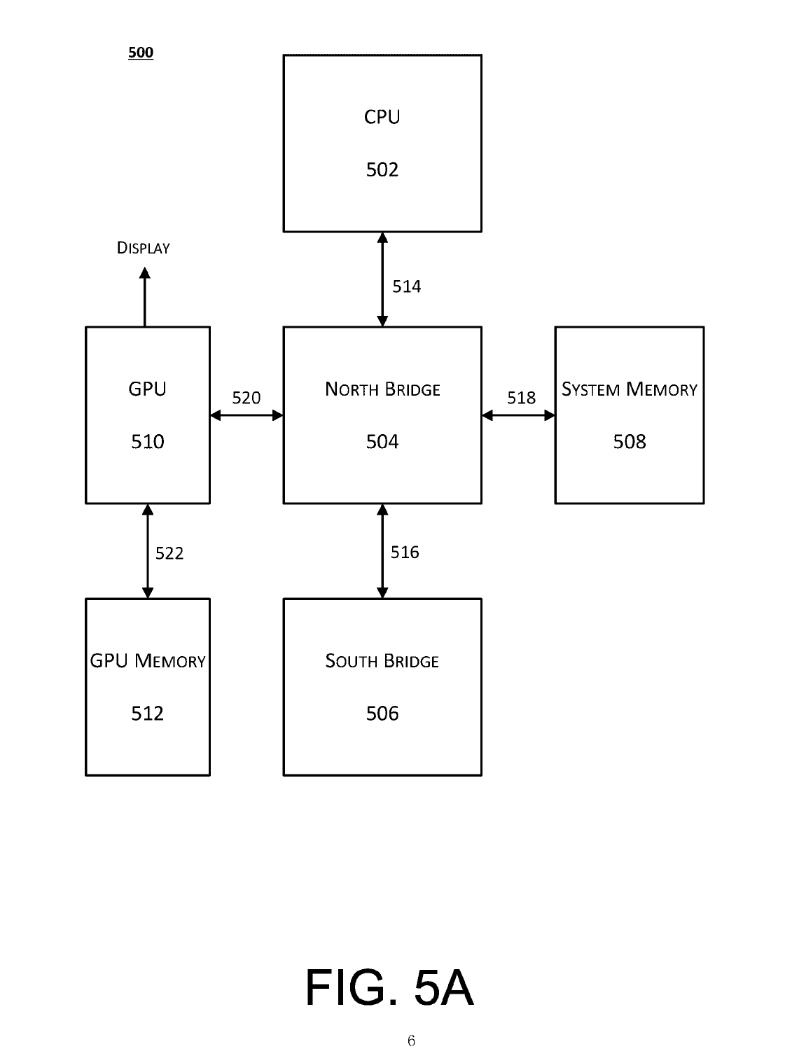

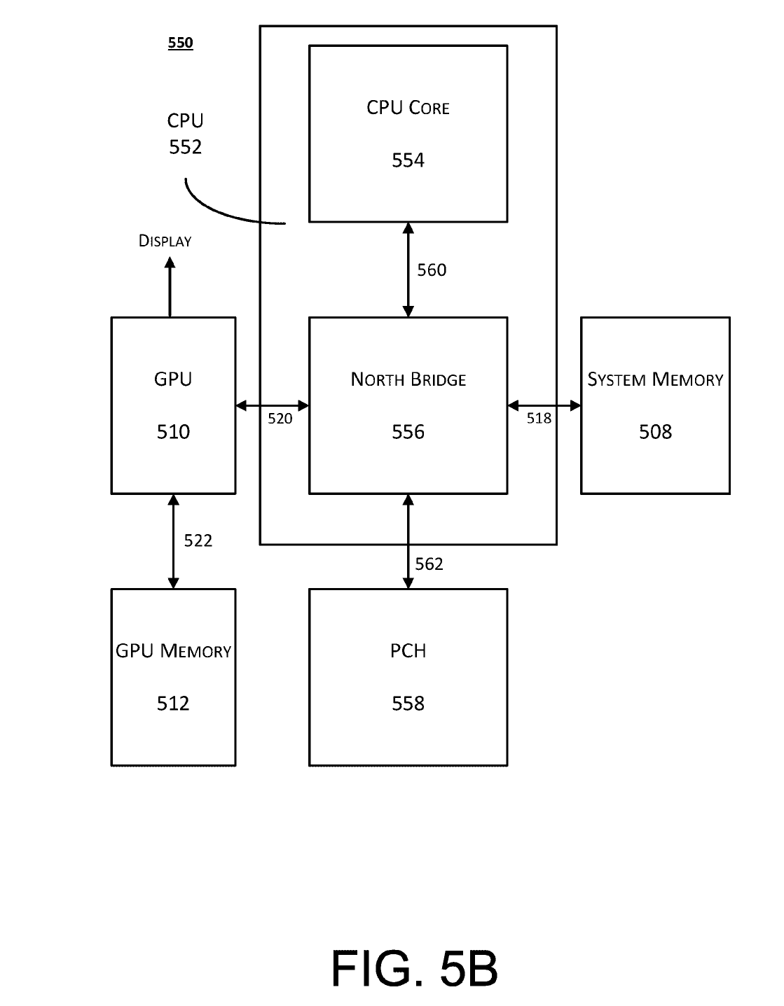

FIGS. 5A and 5B illustrate two heterogeneous computer system architectures, by which at least aspects of interframe prediction may be implemented, in accordance with the present disclosure. These configurations are characterized by a separate CPU and GPU with respective memory subsystems.

FIG. 5A shows a block diagram illustrating an example heterogeneous computer system architecture 500 by which at least aspects of interframe prediction may be implemented. Example computer system architecture 500 includes CPU 502. A north bridge 504 (or host bridge) is connected to the CPU 502 through a front side bus 514, and is paired with a south bridge 506 (or I/O controller hub) through an internal bus 516. The north bridge 504 and the south bridge 506 together manage communications between the CPU 502 and other parts of the PC motherboard, and constitute the core logic chipset of the PC motherboard.

The north bridge 504 handles communications among the CPU 502, the system memory 508, the GPU 510, and the south bridge 506. The north bridge 504 may also include an integrated video controller, also known as a graphics and memory controller hub (GMCH) in Intel systems.

The system memory 508 is connected to the north bridge 504 through a memory bus 518. For example, the system memory 508 may be any type of dynamic random access memory (e.g., DDR3 SDRAM or DDR4 SDRAM).

The GPU 510 is connected to the north bridge 504 through a high-speed graphics bus 520. For example, the high-speed graphics bus 520 may be a 16-lane (x 16) PCI Express (PCIe) link providing at least a 16 GB/s transfer rate. The GPU 510 may also be connected to a dedicated GPU memory 512 through a memory bus 522. For example, the dedicated GPU memory 512 may be any type of graphics random access memory (e.g., GDDR4 or GDDR5), and the memory bus 522 may have a bandwidth of over 300 GB/s.

The south bridge 506 typically implements the slower capabilities of the PC motherboard in a north bridge/south bridge chipset architecture. For example, the south bridge 506 may handle all of the computer system's I/O functions.

In computer system architecture 500, the CPU 502 and the GPU 510 may access each other's memory, albeit with less available bandwidth than their access to the more directly attached memories. A low-cost variation of computer system architecture 500 may use only the system memory 508, omitting the GPU memory 512 from the system. Such a system has a relatively low performance GPU, since the achieved performance is limited by the available system memory bandwidth and increased latency of memory access, whereas dedicated GPU memory provides high bandwidth and low latency.

A high-performance variation of computer system architecture 500 may use multiple attached GPUs, typically two to four GPUs working in parallel. An example is the NVIDIA SLI (scalable link interconnect) multi-GPU system, designed for high performance gaming and workstations.

FIG. 5B shows a block diagram illustrating another example heterogeneous computer system architecture by which at least aspects of interframe prediction may be implemented. System architecture 550 includes CPU 552. Due to the push for system-on-a-chip (SoC) processors, modem devices increasingly have the north bridge integrated into the CPU die itself. As a result, the CPU 552 includes a CPU core 554 connected to a north bridge 556 through an internal bus 560. This architecture removes the problematic performance bottleneck caused by the front side bus 514 between the CPU and the motherboard. Over time, the speed of CPUs kept increasing but the bandwidth of the front side bus did not, resulting in a performance bottleneck. With the north bridge functions integrated into the CPU 552, the front side bus 514 is eliminated and much of the bandwidth needed for chipsets is relieved.

The south bridge is also replaced by a platform controller hub (PCH) 558. All south bridge and I/O functions are managed by the PCH 558 which is connected to the CPU 552 via a direct media interface (DMI) 562.

Depending on the desired configuration, the CPU 502/552 may be of any trpe and may include one or more levels of caching (such as a level one cache and a level two cache), a processor core, and registers. An example processor core may include an arithmetic logic unit (ALU), a floating point unit (FPU), a digital signal processing core (DSP Core), or any combination thereof An example memory controller may also be used with the CPU, or in some implementations the memory controller may be an internal part of the CPU.

Computer system architecture 500/550 may have additional features or functionality, and additional interfaces to facilitate communications between the architecture and any required devices and interfaces. For example, a bus/interface controller may be used to facilitate communications between the architecture and one or more data storage devices via a storage interface bus. Data storage devices may be removable storage devices, non-removable storage devices, or a combination thereof Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory, removable storage devices, and non-removable storage devices are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computer system architecture 500/550. Any such computer storage media may be part of computer system architecture 500/550.

Computer system architecture 500/550 may also include an interface bus for facilitating communication with various interface devices (e.g., output devices, peripheral interfaces, and communication devices) via a bus/interface controller. Example output devices include a graphics processing unit and an audio processing unit, which may be configured to communicate to various external devices such as a display or speakers via one or more A/V ports. Example peripheral interfaces include a serial interface controller or a parallel interface controller, which may be configured to communicate with external devices such as input devices (e.g., keyboard, mouse, pen, voice input device, touch input device, etc.) or other peripheral devices (e.g., printer, scanner, etc.) via one or more I/O ports. An example communication device includes a network controller, which may be arranged to facilitate communications with one or more other computing devices over a network communication link via one or more communication ports.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computer system architecture 500/550 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computer system architecture 500/550 may also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium a fiber optic cable, a waveguide, a wired communications link, a wireless communication link, etc.).

Those skilled in the art will recoanize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g.,“ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g.,“a system having at least one of A, B, or C” would include but not be limited to systems that have A alone, B alone, C alone, A and B together,

A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A motion estimation method, comprising:
dividing a first video frame to be estimated into a plurality of macroblocks, wherein each of the macroblocks includes a plurality of sub-blocks;
determining a sampling pattern for each sub-block based on visual data of the sub-block;
determining a prediction motion vector for each sub-block by performing a pre-search based on the sampling pattern of the sub-block;
determining a search template for each macroblock based on the prediction motion vector of each sub-block within the macroblock; and
determining a prediction motion vector for each macroblock by performing a secondary search based on the search template of the macroblock.

2. The method of claim 1, wherein each macroblock comprises 16×16 samples, and each sub-block comprises 4×4 samples.

3. The method of claim 1, wherein a density of the sampling pattern for each sub-block is based on a visual complexity of the sub-block.

4. The method of claim 3, wherein the sampling pattern for each sub-block comprises at least four sampling points, but no more than approximately half the total number of sampling points in the sub-block.

5. The method of claim 1, wherein the search template for each macroblock comprises a direction, a step length, and a search domain size.

6. The method of claim 1, wherein the method utilizes the H.264 coding standard.

7. The method of claim 1, wherein the pre-search and the secondary search are each performed by a graphics processing unit (GPU).

8. The method of claim 1, wherein the method utilizes the CUDA platform by Nvidia.

9. A non-transitory computer-readable medium having instructions stored thereon that, when executed by a computing device, cause the computing device to perform operations comprising:
dividing a first video frame to be estimated into a plurality of macroblocks, wherein each of the macroblocks includes a plurality of sub-blocks;
determining a sampling pattern for each sub-block based on visual data of the sub-block;
determining a prediction motion vector for each sub-block by performing a pre-search based on the sampling pattern of the sub-block;
determining a search template for each macroblock based on the prediction motion vector of each sub-block within the macroblock; and
determining a prediction motion vector for each macroblock by performing a secondary search based on the search template of the macroblock.

10. The non-transitory computer-readable medium of claim 9, wherein each macroblock comprises 16×16 samples, and each sub-block comprises 4×4 samples.

11. The non-transitory computer-readable medium of claim 9, wherein a density of the sampling pattern for each sub-block is based on a visual complexity of the sub-block.

12. The non-transitory computer-readable medium of claim 11, wherein the sampling pattern for each sub-block comprises at least four sampling points, but no more than approximately half the total number of sampling points in the sub-block.

13. The non-transitory computer-readable medium of claim 9, wherein the search template for each macroblock comprises a direction, a step length, and a search domain size.

14. The non-transitory computer-readable medium of claim 9, wherein the pre-search and the secondary search are each performed by a graphics processing unit (GPU).

15. An apparatus, comprising:
a processor; and
a memory storing instructions that, when executed by the processor, configure the apparatus to:
divide a first video frame to be estimated into a plurality of macroblocks, wherein each of the macroblocks includes a plurality of sub-blocks,
determine a sampling pattern for each sub-block based on visual data of the sub-block,
determine a prediction motion vector for each sub-block by performing a pre-search based on the sampling pattern of the sub-block,
determine a search template for each macroblock based on the prediction motion vector of each sub-block within the macroblock, and
determine a prediction motion vector for each macroblock by performing a secondary search based on the search template of the macroblock.

16. The apparatus of claim 15, wherein each macroblock comprises 16×16 samples, and each sub-block comprises 4×4 samples.

17. The apparatus of claim 15, wherein a density of the sampling pattern for each sub-block is based on a visual complexity of the sub-block.

18. The apparatus of claim 17, wherein the sampling pattern for each sub-block comprises at least four sampling points, but no more than approximately half the total number of sampling points in the sub-block.

19. The apparatus of claim 15, wherein the search template for each macroblock comprises a direction, a step length, and a search domain size.

20. The apparatus of claim 15, wherein the pre-search and the secondary search are each performed by a graphics processing unit (GPU).

We claim:

1. A motion estimation method, comprising:
dividing a first video frame to be estimated into a plurality of macroblocks, wherein each of the macroblocks includes a plurality of sub-blocks;
determining a sampling pattern for each sub-block based on visual data of the sub-block;
determining a prediction motion vector for each sub-block by performing a pre-search based on the sampling pattern of the sub-block;
determining a search template for each macroblock based on the prediction motion vector of each sub-block within the macroblock; and
determining a prediction motion vector for each macroblock by performing a secondary search based on the search template of the macroblock.

2. The method of claim 1, wherein each macroblock comprises 16×16 samples, and each sub-block comprises 4×4 samples.

3. The method of claim 1, wherein a density of the sampling pattern for each sub-block is based on a visual complexity of the sub-block.

4. The method of claim 3, wherein the sampling pattern for each sub-block comprises at least four sampling points, but no more than approximately half the total number of sampling points in the sub-block.

5. The method of claim 1, wherein the search template for each macroblock comprises a direction, a step length, and a search domain size.

6. The method of claim 1, wherein the method utilizes the H.264 coding standard.

7. The method of claim 1, wherein the pre-search and the secondary search are each performed by a graphics processing unit (GPU).

8. The method of claim 1, wherein the method utilizes the CUDA platform by Nvidia.

9. A non-transitory computer-readable medium having instructions stored thereon that, when executed by a computing device, cause the computing device to perform operations comprising:
dividing a first video frame to be estimated into a plurality of macroblocks, wherein each of the macroblocks includes a plurality of sub-blocks;
determining a sampling pattern for each sub-block based on visual data of the sub-block;
determining a prediction motion vector for each sub-block by performing a pre-search based on the sampling pattern of the sub-block;
determining a search template for each macroblock based on the prediction motion vector of each sub-block within the macroblock; and
determining a prediction motion vector for each macroblock by performing a secondary search based on the search template of the macroblock.

10. The non-transitory computer-readable medium of claim 9, wherein each macroblock comprises 16×16 samples, and each sub-block comprises 4×4 samples.

11. The non-transitory computer-readable medium of claim 9, wherein a density of the sampling pattern for each sub-block is based on a visual complexity of the sub-block.

12. The non-transitory computer-readable medium of claim 11, wherein the sampling pattern for each sub-block comprises at least four sampling points, but no more than approximately half the total number of sampling points in the sub-block.

13. The non-transitory computer-readable medium of claim 9, wherein the search template for each macroblock comprises a direction, a step length, and a search domain size.

14. The non-transitory computer-readable medium of claim 9, wherein the pre-search and the secondary search are each performed by a graphics processing unit (GPU).

15. An apparatus, comprising:
a processor; and
a memory storing instructions that, when executed by the processor, configure the apparatus to:
divide a first video frame to be estimated into a plurality of macroblocks, wherein each of the macroblocks includes a plurality of sub-blocks,
determine a sampling pattern for each sub-block based on visual data of the sub-block,
determine a prediction motion vector for each sub-block by performing a pre-search based on the sampling pattern of the sub-block,
determine a search template for each macroblock based on the prediction motion vector of each sub-block within the macroblock, and
determine a prediction motion vector for each macroblock by performing a secondary search based on the search template of the macroblock.

16. The apparatus of claim 15, wherein each macroblock comprises 16×16 samples, and each sub-block comprises 4×4 samples.

17. The apparatus of claim 15, wherein a density of the sampling pattern for each sub-block is based on a visual complexity of the sub-block.

18. The apparatus of claim 17, wherein the sampling pattern for each sub-block comprises at least four sampling points, but no more than approximately half the total number of sampling points in the sub-block.

19. The apparatus of claim 15, wherein the search template for each macroblock comprises a direction, a step length, and a search domain size.

20. The apparatus of claim 15, wherein the pre-search and the secondary search are each performed by a graphics processing unit (GPU).
